(19) United States
(12) Patent Application Publication
(10) Pub. No.: US 2024/0343219 A1
(43) Pub. Date: Oct. 17, 2024

(54) PROTECTION MODULE FOR MOTOR VEHICLE INTENDED TO PROTECT A PEDESTRIAN IN THE EVENT OF AN IMPACT

(71) Applicant: ENVIRPROD, Les Ulis (FR)

(72) Inventors: Abraham MORENO REYNA, Paris (FR); Catherine SANJEU, Marcoussis (FR)

(21) Appl. No.: 18/260,843

(22) PCT Filed: Jan. 5, 2022
(86) PCT No.: PCT/EP2022/050150

§ 371 Date: Jun. 27, 2024

(30) Foreign Application Priority Data
Jan. 8, 2021 (FR) 2100169
Dec. 28, 2021 (FR) 2114565

(51) Int. Cl. B60R 21/36; B60R 19/20

(52) U.S. Cl. CPC B60R 21/36; B60R 19/20

(57) ABSTRACT

The invention relates to a protection module for protecting a pedestrian in the event of an impact between the front face of said vehicle and said pedestrian, said vehicle having a bumper and said protection module comprising an inflatable structure which, in a rest position, is integrated in the front face of said vehicle or in the rear part of the hood of said vehicle at the corner of the windscreen and which, in a protection position, is deployed outwards from the front face or from the rear part of the hood at the corner of the windscreen, said protection module further having a gas-generating device for inflating said inflatable structure characterized in that said inflatable structure is integrated in the front face of said vehicle or in the rear part of the hood at the corner of the windscreen, is deployed outwards from the front face or from the rear part of the hood at the corner of the windscreen, said protection module further comprising a gas-generating device for inflating said inflatable structure characterized in that said inflatable structure comprises a first impact section (10) arranged on the bumper of said vehicle and a second impact section arranged on the hood of said vehicle, each impact section (10) comprising a retaining means (11).

The invention concerns a protection module designed to be fitted to a vehicle, in particular a motor vehicle. The protection module is designed to protect a pedestrian in the event of impact with the front of the motor vehicle.

The state of the art is known from document DE 101 21 630 A1, which discloses a device for restraining a pedestrian in the event of impact with the front of a motor vehicle, thereby preventing a second impact. Referring to FIGS. 7, 8, 9a, 9b of this document, a pair of arms 38 forming a bottom wall 37 and another pair of arms 39 forming a top wall 38 are provided. The pair of arms 38, 39 are connected to the front bumper of the motor vehicle by a pivot connection. The device also includes a net 40 arranged between the pair of arms 38 to restrain the pedestrian. This document also discloses another example of the device in which two inflatable arms 105, 106 are provided and a restraining net 107 arranged between the two inflatable arms. According to another embodiment, illustrated in FIGS. 18 to 21, the device comprises airbag forks 114 supporting a frame airbag 115 and a locking wall 121 for restraining the pedestrian during impact.

Also known from the prior art is document DE 102 13 178 A1, which discloses a device for restraining a pedestrian in the event of an impact with the front of a motor vehicle, so as to avoid a second impact. It comprises guide airbags 8, bumper airbags 12 and side airbags 14, as well as a retaining wall 5 which can be a net, combined with an airbag, or an airbag, deploying from the ground. The deployed retaining wall 5 is held in place by taut ropes 7 when the guide airbags 8 are deployed. The retaining wall 5 may be an inflatable mattress.

Also known is EP 3 409 542 A1, which discloses a device 100 for reducing injuries to a road user 1 in the event of a collision with a motor vehicle 400, such as a truck. The device 100 prevents the road user 1 from rebounding in the event of impact with the front part of the motor vehicle. The device 100 comprises an airbag 106 with at least one impact section 112 and a restraint section 114 designed to transmit forces opposite to the direction of travel to the road user 1. The device 100 further comprises a control, linked to the driver interface, configured, in response to the detection of the road user 1, to fill said impact section 112 up to a first instant in response to the seizure of the road user 1, and to fill said one restraint section 114 up to a second subsequent instant. The impact section 112 and the retaining section 114 may each comprise two parts. The restraint section 114, and optionally one or each partial area of the restraint section 114, may be in fluid connection with the impact section 112 via a plurality of passage openings.

Also known is U.S. Pat. No. 10,029,638, which discloses an airbag system comprising arms 221, 223 for reducing a second impact due to the rebound of a first impact. With reference to FIG. 4, the airbag system surrounds the pedestrian. The arms 221, 223 can be closed by supports 340, and means are provided for attaching the ends of the arms 221, 223, such as glue, hook or Velcro®.

Also known is CN 101973238 A, which discloses a motor vehicle bumper airbag designed to protect a pedestrian in the event of impact with the front part of the motor vehicle. The airbag comprises two arms 2 arranged to surround the pedestrian.

The disadvantage of these various devices for protecting a pedestrian in the event of impact with the front of a motor vehicle is that they only partially protect the pedestrian. Indeed, during a first impact with the motor vehicle, the pedestrian may still suffer a projection or rebound that could lead to a second impact and thus potentially cause injury, particularly to the upper body, and more particularly to the head. Thus, prior art devices only partially address pedestrian protection in the event of a second impact.

The aim of the invention is therefore to overcome the disadvantages of the prior art by proposing a protection module for a motor vehicle configured to protect a pedestrian in the event of impact against the front part of the said motor vehicle configured in such a way as to improve the protection of the pedestrian struck with the aim of minimizing the injuries caused by the impact.

For this purpose, the invention thus relates, in its broadest acceptance, to a protection module for a vehicle for protecting in the event of an impact between the front face of said vehicle and said pedestrian, said vehicle having a bumper, said protection module comprising an inflatable structure which, in a rest position, is configured to be integrated in the front face of said vehicle or in the rear part of the hood of said vehicle at the corner of the windscreen and which, in a protection position is configured to be deployed outwards from the front face or from the rear part of the hood at the corner of the windscreen, said protection module further comprising a gas-generating device for inflating said inflatable structure characterized in that said inflatable structure comprises a first impact section configured to be arranged on the bumper of said vehicle and a second impact section configured to be arranged on the hood of said vehicle, each impact section comprising retaining means configured to surround, in the protection position, at least half the circumference of the pedestrian's body.

Thanks to the present invention, the pedestrian's entire body is protected in the event of impact with the front part of a vehicle. The invention thus makes it possible to reduce or even eliminate the injuries caused to the pedestrian.

Advantageously, the second impact section comprises a mattress.

A mattress has the effect of further reducing the impact between the pedestrian's upper body and the vehicle, and more particularly between the head and the hood of the vehicle. Injuries to the pedestrian's upper body are thus reduced or even eliminated.

Preferably, the second impact section comprises a frame in the form of a right prism having a vertical front face and a substantially inclined rear face comprising an aperture and two side faces each comprising an aperture, said frame being configured to deploy forward onto the hood.

Such an armature provides cushioning for the pedestrian's upper body in the event of impact with the front of a vehicle.

Preferably, said frame comprises a set of vertical arms forming said restraint means.

The set of vertical arms restrains the pedestrian to prevent him from being thrown off during a second impact.

Preferably, said restraint means comprises two arms which are able to be joined together to form an arc of a circle.

In this way, the pedestrian is held in place to avoid being thrown out of the vehicle.

Preferably, said retaining means comprises a parabolic or semicircular horizontal tube.

Preferably, said retaining means comprises extensions configured to be held together upon impact between the pedestrian and the motor vehicle by means of a retaining device.

Preferably, said holding device is an adhesive, glue or quick-coupling device comprising two textile strips each coated with a different texture.

The advantage of such a holding device is that it reinforces the pedestrian's hold after impact.

Preferably, said restraint comprises a band.

The band cushions the pedestrian and also enables the arms of the restraint to be bent quickly. Pedestrian projection following impact with the vehicle is reduced or even eliminated.

The invention also concerns a motor vehicle comprising a protection module according to the present invention.

The following are non-limiting examples of various methods of implementing the present invention, with reference to the appended figures, in which:

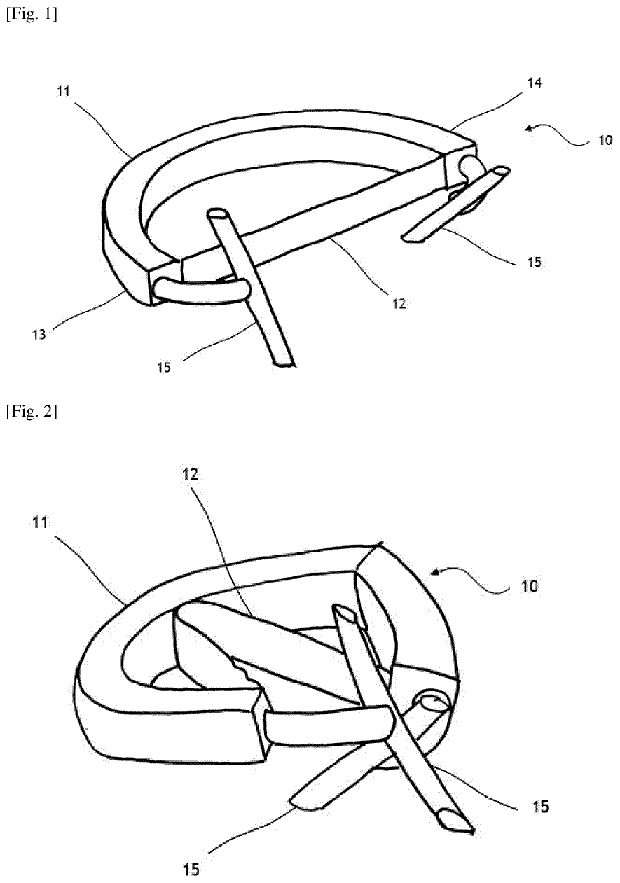

FIG. 1 schematically illustrates an isometric view of the lower part of a motor vehicle protection module according to a preferred embodiment of the present invention, in the protection position;

FIG. 2 schematically illustrates an isometric view of the lower part of the protection module shown in FIG. 1 in the protection and restraint position;

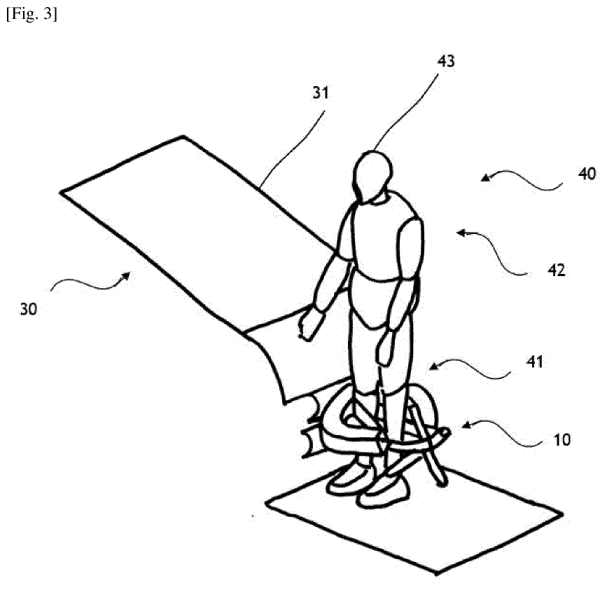

FIG. 3 is a schematic representation of the protective module shown in FIG. 2, surrounding a pedestrian's legs in the event of an impact with the front part of the motor vehicle;

FIG. 4 schematically represents a side view of the protection module surrounding a pedestrian's legs shown in FIG. 3;

FIG. 5 schematically illustrates the upper part of the motor vehicle protection module according to a first embodiment of the present invention;

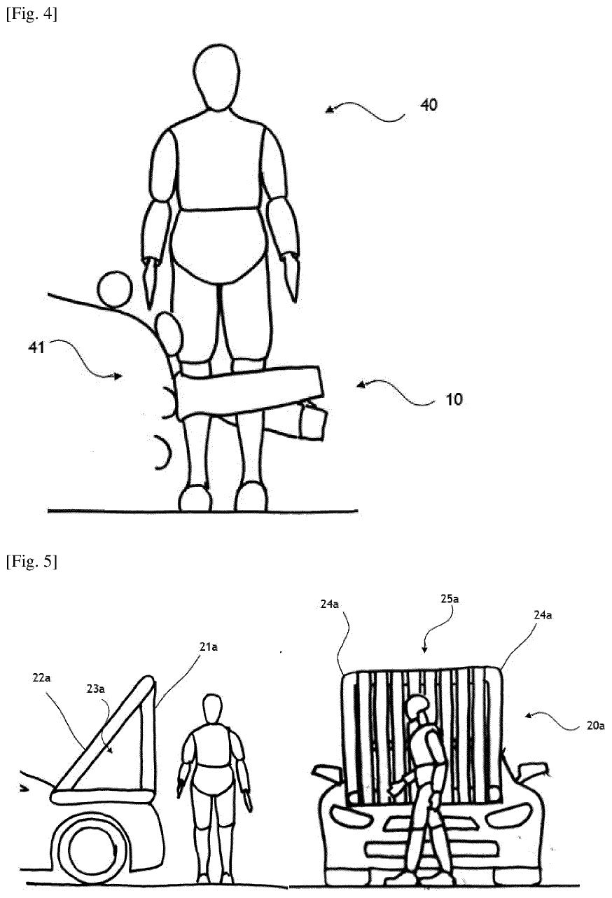

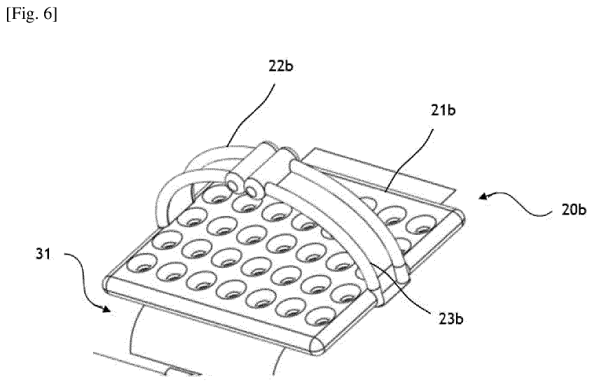

FIG. 6 schematically illustrates the upper part of the motor vehicle protection module according to a second embodiment of the present invention.

The present invention concerns, according to its most general acceptance, a protection module for a motor vehicle for protecting a pedestrian during an impact against the front face of said motor vehicle. The protection module comprises an inflatable structure. The inflatable structure is a pedestrian airbag made up of two separate inflatable parts: a lower part 10, also known as the first impact section or bumper section, designed to accommodate the pedestrian's legs, and an upper part 20a, 20b, also known as the second impact section or hood section, designed to accommodate the pedestrian's upper body, particularly the head.

In the rest position, the inflatable structure is integrated into the front of the vehicle or into the rear part of the hood at the corner of the windshield. In the protection position, i.e. the position of the protection module to protect the pedestrian in the event of an impact with the front of the motor vehicle, the inflatable structure is deployed outwards from the front of the vehicle or from the rear of the hood at the corner of the windscreen.

Each part of the inflatable structure comprises pedestrian restraint means arranged to limit the projection or rebound of the pedestrian as a result of the first impact with the front face of a vehicle. Each restraint means is in fluid communication with its part.

The lower part 10 of the protection module, also known as the pedestrian airbag device, protects the pedestrian in the event of an initial impact between the pedestrian and the vehicle, and acts as a restraint for the pedestrian's lower body. If a vehicle cannot avoid impact with a pedestrian, the vehicle collision detection system activates the protection module in a sufficiently short time to deploy the lower part 10 and protect the pedestrian. In the event of a collision between a vehicle 30 and a pedestrian 40, a first impact is produced on the pedestrian's lower part 41, as shown in FIG. 3. After this first impact, the lower part of pedestrian 41 begins to be ejected in the same direction as the vehicle due to the impact energy between vehicle 30 and pedestrian 40, with the rest of pedestrian 40's body following this trajectory. The pedestrian 40 may rotate about its center of gravity as the vehicle 30 continues its impact trajectory, which may cause the upper part of the pedestrian 42 to strike the vehicle 30, mainly in the head area 43. As the pedestrian 40 is ejected in the same direction as the vehicle 30, it is likely to undergo a second impact, for example against the ground or another object, after being ejected by the first impact. The lower part 10 of the protection module protects the pedestrian 40 from the first impact with the vehicle 30. Its lower part 10 restraint system minimizes ejection energy and slows down the rotational movement of pedestrian 40. The lower part 10 of the protection module can be mounted in conjunction with the upper part 20 of the protection module. In this situation, the lower part 10 and the upper part 20 of the protection module could be activated independently and at different times.

The lower part 10 of the protection module modifies the impact dynamics of pedestrian 40 after the first impact between pedestrian 40 and vehicle 30.

FIG. 1 illustrates an isometric view of the lower part 10 of the protection module according to a preferred embodiment of the present invention. The lower part 10 of the protection module consists mainly of a parabolic, or alternatively semicircular, horizontal tube 11, which protects the lower part 41 of the pedestrian 40 during the first impact with the vehicle. The lower part 10 of the protection module may include straight horizontal tubes (not shown) to increase the protection area, and these straight horizontal tubes are in fluid communication with the horizontal semi-circular or parabolic tube 11 of the lower part 10 of the protection module. Deployment of the straight horizontal tubes and the parabolic or semicircular horizontal tube 11 may take place at the same time or at a later date, before the first collision with the pedestrian 40. The lower part 10 of the protection module in its horizontal tube 11, parabolic or semicircular, is fixed to the structure of the vehicle 30 at the rear and will deploy before impact with the pedestrian 40. Straight horizontal tubes may have a different fastening system to that of the horizontal tube 11. The vehicle 30 includes an impending pedestrian collision detection system 40 that activates the pedestrian protection module sufficiently in advance of the first impact for it to deploy and function correctly.

The horizontal tube 11, or horizontal tubes, may be configured to absorb the forces of the initial impact. The cross-section of the horizontal tubes may cover the front part of the vehicle 30 that is likely to be impacted. The lower part 10 of the protection module can be stored at the front of the vehicle 30 in its attachment area.

The lower part 10 of the protective module also comprises a strip 12 connecting a first outer arm 13 and a second outer arm 14. The band 12, also known as the union band or union element, can be made of the same material as the rest of the lower part 10 of the protective module. Alternatively, the band 12 may comprise cables, a cable matrix or another material to achieve the functionality of the band 12. The strip 12 receives the first contact with the pedestrian 40. The impact force between band 12 and pedestrian 40 deforms the horizontal tube 11 through the union band. The function of band 12 is to bend the outer arms 13, 14 of horizontal tube 11 inwards, as shown in FIGS. 2 and 3. FIG. 2 illustrates the deformation effect at the moment of impact between pedestrian 40 and band 12. The outer arms 13, 14 have extensions 15 in relation to the horizontal tube 11 after the band 12. The function of these extensions 15 is to lie behind the impact zone between the pedestrian 40 and the horizontal tube 11, surrounding the lower part 41 of the pedestrian 40 and generating a self-locking union. Upon contact, the extensions 15 are held together by adhesive, glue or quick-coupling devices, such as a system consisting of two textile strips, each covered with a different texture, which, when brought into contact, produce a detachable connection, known under the brand name Velcro®. In this way, the horizontal tube 11, together with the extensions 15, are arranged around the lower part 41 of the pedestrian 40 after the first impact. Afterwards, the self-locking union of the extensions 15 of the horizontal tube 11 is maintained throughout the collision between the pedestrian 40 and the vehicle 30 until it comes to a stop. The horizontal tube(s) could be configured to absorb collision energy. However, this does not prevent the first impact from ejecting the lower part 41 of pedestrian 40 towards vehicle 30. The self-locking horizontal tube 11 extensions 15 can reduce, or even prevent, the rotation of the pedestrian 40 relative to its center of gravity, generated during the first impact on the inner face, by closing around the lower face of the pedestrian 40. This connection around the lower part 41 of the pedestrian 40 can reduce the accelerations generated after the first impact and consequently minimize ejection speeds.

With reference now to FIG. 5, a side view and a front view of a first embodiment of the top part 20a of the protection module according to the invention are illustrated. The top part 20a of the protection module has a frame in the form of a straight prism with a vertical front face 21a and a substantially inclined rear face 22a comprising an opening and two side faces 23a comprising an opening, extending forward onto the hood. The absorption means of the upper part 20a comprises a set of interconnected tubes forming the prism frame and a set of vertical tubes 24a arranged at the front face. The upper part 20a is supplied by a gas generator (not shown) fixed to the structure of the vehicle 30 and connected to the tubes by a supply pipe. The upper part 20a also comprises a set of vertical arms 25a forming a means of restraining the pedestrian 40, or limiting the effect of projection, or rebound, due to impact with the front face of the vehicle 40.

With reference to FIG. 6, an isometric view is shown of a second embodiment of the top part 20b of the protection module according to the invention. The upper part 20b comprises a mattress 21b extending along the hood 31 and two arms 22b, 23b extending from the mattress 21b so as to form a semicircle when the two arms 22b, 23b are connected and held together. The mattress 21b absorbs the kinetic energy of the pedestrian 40 on the hood 31. The deployment of the two arms 22b, 23b takes place after the impact of the pedestrian 40 on the mattress 21b, so that the pedestrian 40 can be restrained and prevented from falling onto an element of the external environment.

1. A protection module for a vehicle (30) for protecting a pedestrian (40) in the event of an impact between the front face of said vehicle (30) and said pedestrian (40), said vehicle (30) comprising a bumper, said protection module comprising an inflatable structure which, in a rest position, is configured to be integrated into the front face of said vehicle (30) or into the rear part of the hood (31) of said vehicle (30) at the corner of the windshield and which, in a protection position, is configured to be deployed outwards from the front face or from the rear part of the hood (31) at the corner of the windshield, said protection module further comprising a gas-generating device for inflating said inflatable structure characterized in that said inflatable structure comprises a first impact section (10) configured to be arranged on the bumper of said vehicle (30) and a second impact section (20a, 20b) configured to be arranged on the hood (31) of said vehicle (30), each impact section (10, 20a, 20b) comprising retaining means (11, 21a, 22b, 23b, 25a) configured to surround, in the protective position, at least half the circumference of the pedestrian's body (40).

2. Module according to claim 1, characterized in that the second impact section (20b) comprises a mattress (21b).

3. Module according to claim 1, characterized in that the second impact section (20a) comprises a frame in the form of a right prism having a vertical front face (21a) and a substantially inclined rear face (22a) comprising an opening and two lateral faces (23a) each comprising an opening, the said frame being configured to be deployed forward onto the hood (31).

4. Module according to claim 3, characterized in that said frame comprises a set of vertical arms (25a) forming said retaining means.

5. Module according to any one of claims 1 to 2, characterized in that said retaining means comprises two arms (13, 14, 22b, 23b) which are able to be joined together to form an arc of a circle.

6. Module according to any one of claims 1 to 2, characterized in that said retaining means comprises a parabolic or semicircular horizontal tube (11).

7. Module according to any one of claims 5 to 6, characterized in that said retaining means comprises extensions (15) configured to be held together in the event of an impact between the pedestrian (40) and the motor vehicle (30) by means of a holding device.

8. Module according to claim 7, characterized in that said holding device is an adhesive, a glue or a quick-coupling device comprising two textile strips each coated with a different texture.

9. Module according to any one of claims 5 to 8, characterized in that said retaining means comprises a strip (12).

10. Motor vehicle comprising a protection module according to any one of claims 1 to 9.
